(19) United States
(12) Patent Application Publication
(10) Pub. No.: US 2018/0081594 A1
(43) Pub. Date: Mar. 22, 2018

(54) STORAGE DEVICE AND METHOD OF OPERATING THE SAME

(71) Applicant: SAMSUNG ELECTRONICS CO., LTD., SUWON-SI (KR)

(72) Inventors: SANG-WON JUNG, Busan (KR); Yoon-Young Kyung, Suwon-si (KR); Hyun-Jin Choi, Suwon-si (KR); Ji-Soo Kim, Seongnam-si (KR); Joon-Ho Lee, Hwaseong-si (KR); Walter Jun, Seoul (KR); Jae-Sung Jung, Hwaseong-si (KR); Jun-Seok Park, Seoul (KR); Young-Woo Jung, Gunpo-si (KR)

(21) Appl. No.: 15/605,148

(22) Filed: May 25, 2017

(30) Foreign Application Priority Data
Sep. 19, 2016 (KR) 10-2016-0119560

(51) Int. Cl. G06F 3/06

(52) U.S. Cl. CPC G06F 3/0659; G06F 3/0673; G06F 3/0613

(57) ABSTRACT

A method of operating a storage device including first and second memory regions includes adjusting a write ratio of the first memory region to the second memory region for write data received from a host in response to a write request from the host, and writing the write data to the first and second memory regions at the adjusted write ratio. The first memory region includes memory cells having a first write speed, and the second memory region includes memory cells having a second write speed that is different from the first write speed.

### CROSS-REFERENCE TO RELATED APPLICATION

This application claims priority to Korean Patent Application No. 10-2016-0119560, filed on September 19, 2016, in the Korean Intellectual Property Office, the disclosure of which is incorporated by reference in its entirety herein.

### BACKGROUND

### 1. Technical Field

The inventive concept relates to a storage device, and a method of operating the storage device.

### 2. Discussion of Related Art

A computer system may include various types of memory systems, each of which includes a memory device and a controller. The memory device is used to store data. The memory device may be implemented with a volatile memory device or a non-volatile memory device. The volatile memory device requires power maintain the stored data. The non-volatile memory device retains the stored data even after power is no longer applied. The memory device may include first and second memory regions. A write speed of the first memory region may be different from a write speed of the second memory region.

### SUMMARY

According to an exemplary embodiment of the inventive concept, there is provided a method of operating a storage device including first and second memory regions, the method including a controller of the storage device adjusting a write ratio of the first memory region to the second memory region for write data received from a host in response to a write request from the host, and the controller writing the write data to the first and second memory regions at the adjusted write ratio, wherein the first memory region includes memory cells having a first write speed, and the second memory region includes memory cells having a second write speed that is different from the first write speed.

According to an exemplary embodiment of the inventive concept, there is provided a method of operating a storage device including first and second memory regions, the method including a controller of the storage device monitoring a workload of the storage device based on a write request and write data received from a host during a first period, adjusting a write ratio of the first memory region to the second memory region for the received write data based on the monitored workload, and writing the write data to the first and second memory regions at the adjusted write ratio, wherein the first memory region includes memory cells having a first write speed, and the second memory region includes memory cells having a second write speed that is different from the first write speed.

According to an exemplary embodiment of the inventive concept, there is provided a storage device including a memory including a first memory region including memory cells having a first write speed and a second memory region including memory cells having a second write speed that is different from the first write speed, and a controller configured to receive a write request and write data from a host, to dynamically adjust a write ratio of the first memory region to the second memory region for the received write data, and to control the memory to write the write data to the first and second memory regions that are at the adjusted write ratio.

According to an exemplary embodiment of the inventive concept, there is provided a storage device including a memory device and a controller. The memory device includes a single level cell (SLC) region and a multi level cell (MLC) region, wherein the memory device stores a write ratio X:Y, where X is a first amount of data to write to the SLC region and Y is a second amount of data to write to the MLC region, where X is different from Y. The controller is configured to receive a write mode and write data from a host, adjust the write ratio based on the write mode, and write the write data to the SLC region and the MLC region according to the adjusted write ratio.

### BRIEF DESCRIPTION OF THE DRAWINGS

Embodiments of the inventive concept will be more clearly understood from the following detailed description taken in conjunction with the accompanying drawings in which:

FIG. 1 is a block diagram of a storage system according to an exemplary embodiment of the inventive concept;

FIG. 2 is a block diagram illustrating an example of a storage device of FIG. 1 according to an exemplary embodiment of the inventive concept;

FIGS. 3A and 3B illustrate examples of a memory of FIG. 2;

FIG. 4 is a block diagram illustrating an example of a controller of FIG. 2;

FIG. 5 illustrates a single level cell (SLC) write operation and first to third mixed write operations that are performed on the memory of FIG. 2 at a plurality of write ratios, according to an exemplary embodiment of the inventive concept;

FIG. 6 illustrates mixed write operations at a plurality of write ratios, according to an exemplary embodiment of the inventive concept;

FIGS. 7A and 7B respectively illustrate the SLC write operation and the first to third mixed write operations of FIG. 5, according to an exemplary embodiment of the inventive concept;

FIGS. 8A to 8C illustrate a mixed write operation and a migration operation, according to some exemplary embodiments of the inventive concept;

FIG. 9 is a graph showing a relationship between buffer size and performance when a write operation is performed at a plurality of write ratios, according to an exemplary embodiment of the inventive concept;

FIG. 10 is a graph showing a lifetime of the storage device at a plurality of write ratios, according to an exemplary embodiment of the inventive concept;

FIG. 11 is a graph showing performance, buffer size, and lifetime of the storage device at a plurality of write ratios, according to an exemplary embodiment of the inventive concept;

FIG. 12 is a flowchart of a method of operating a storage device, according to an exemplary embodiment of the inventive concept;

FIG. 13 is a flowchart of a method of operating a storage device, according to an exemplary embodiment of the inventive concept;

FIG. 14 is a flowchart of an operation between a host and a storage device, according to an exemplary embodiment of the inventive concept;

FIG. 15 is a table showing an example of information provided in operation S210 of FIG. 14;

FIG. 16 is a flowchart of a method of operating a storage device, according to an exemplary embodiment of the inventive concept;

FIG. 17 is a graph showing a lifetime of a storage device when a write ratio changes with time, according to an exemplary embodiment of the inventive concept;

FIG. 18 is a block diagram illustrating another example of the storage device of FIG. 1, according to an exemplary embodiment of the inventive concept;

FIG. 19 illustrates mixed write operations with respect to memories of FIG. 18 at a plurality of write ratios, according to an exemplary embodiment of the inventive concept;

FIG. 20 illustrates the mixed write operations of FIG. 19, according to an exemplary embodiment of the inventive concept;

FIG. 21 is a block diagram illustrating another example of the storage device of FIG. 1, according to an exemplary embodiment of the inventive concept;

FIG. 22 is a graph showing first and second periods applied to a workload monitor of FIG. 21;

FIGS. 23A to 23C are graphs showing an operation of a storage device according to a workload, according to an exemplary embodiment of the inventive concept;

FIG. 24 is a flowchart of a method of operating a storage device, according to an exemplary embodiment of the inventive concept;

FIG. 25 is a block diagram illustrating another example of the storage device of FIG. 1, according to an exemplary embodiment of the inventive concept;

FIG. 26 is a block diagram illustrating another example of the storage device of FIG. 1, according to an exemplary embodiment of the inventive concept; and

FIG. 27 is a block diagram of an electronic apparatus according to an exemplary embodiment.

### DETAILED DESCRIPTION OF THE EXEMPLARY EMBODIMENTS

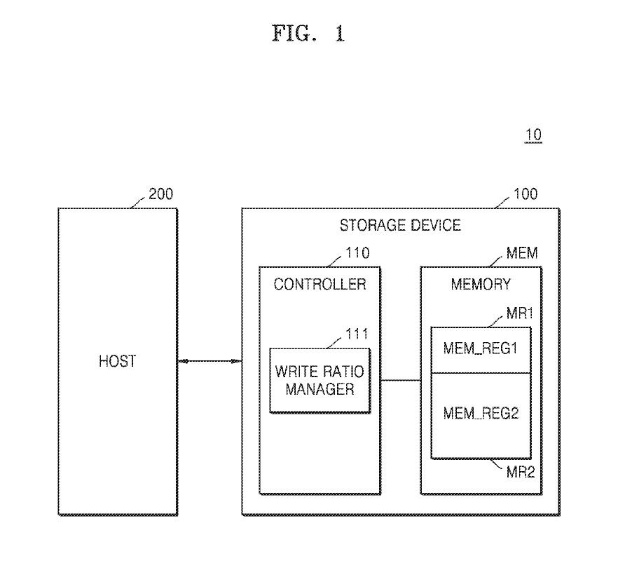

FIG. 1 is a block diagram of a storage system 10 according to an exemplary embodiment of the inventive concept.

Referring to FIG. 1, the storage system 10 includes a storage device 100 and a host 200 (e.g., a host device). The storage system 10 may be implemented by an electronic device, such as a personal computer (PC), a laptop computer, a mobile terminal, a smartphone, a tablet PC, a personal digital assistant (PDA), an enterprise digital assistant (EDA), a digital still camera, a digital video camera, an audio device, a portable multimedia player (PMP), a personal navigation device (PND), an MP3 player, a handheld game console, or an e-book reader. Also, the storage system 10 may be implemented by a wearable device, such as a wrist watch (e.g., a smartwatch) or a head-mounted display (HMD).

The storage device 100 includes a controller 110 and a memory MEM. The memory MEM includes first and second memory regions MR1 and MR2 having different performances. In an embodiment, the first memory region MR1 is capable of being written at a first write speed and the second memory region MR2 is capable of being written at a second other write speed. However, embodiments of the inventive concept are not limited thereto. The storage device 100 may further include other memory regions besides the first and second memory regions MR1 and MR2. In the present embodiment, the first memory region MR1 includes memory cells capable of being written at the first write speed, and the second memory region MR2 includes memory cells capable of being written at the second write speed that is different from the first write speed.

In an exemplary embodiment, the first and second memory regions MR1 and MR2 are implemented in a single memory chip. For example, the first memory region MR1 may correspond to some blocks or pages of the single memory chip, and the second memory region MR2 may correspond to other blocks or pages of the single memory chip. In an exemplary embodiment, the first and second memory regions MR1 and MR2 are implemented by different chips. For example, a first memory chip may be used to implement the first memory region MR1 and second other memory chip may be used to implement the second memory region MR2. In an embodiment, the first memory region MR1 is a volatile memory and the second memory region MR2 is a non-volatile memory. In an embodiment, the first and second memory regions MR1 and MR2 are both volatile memories. In an embodiment, the first and second memory regions MR1 and MR2 are both non-volatile memories.

In an embodiment, the first and second memory regions MR1 and MR2 are both homogeneous memory (for example, planar NAND or VNAND). In this regard, the number of bits writable to each memory cell included in the first memory region MR1 may be different from the number of bits writable to each memory cell included in the second memory region MR2. For example, the first memory region MR1 may be a single level cell (SLC) region and the second memory region MR2 may be a multi level cell (MLC) region or a triple level cell (TLC) region. In another example, the first memory region MR1 may be a fast SLC region and the second memory region MR2 may be a slow SLC region.

In an embodiment, the first and second memory regions MR1 and MR2 are heterogeneous memories having different performances. For example, the first memory region MR1 may be a low latency NAND (LLNAND) flash memory and the second memory region MR2 may be a vertical NAND (VNAND) flash memory. In an embodiment, the first and second memory regions MR1 and MR2 are heterogeneous memories having different characteristics. For example, the first memory region MR1 may correspond to phase-change random access memory (PRAM) and the second memory region MR2 may correspond to NAND flash memory. In another example, the first memory region MR1 may correspond to static RAM (SRAM), the second memory region MR2 may correspond to dynamic RAM (DRAM), and the memory MEM may be a cache device.

The controller 110 controls the memory MEM to write data to the memory MEM in response to a write request received from the host 200. In a present exemplary embodiment, the controller 110 includes a write ratio manager 111. The write ratio manager 111 dynamically adjusts a write ratio of the first memory region MR1 to the second memory region MR2 for write data. The “write ratio” may be defined as a ratio of the amount of data to be written to the first memory region MR1 to the amount of data to be written to the second memory region MR2. For example, the first memory region MR1 is written with X data units (bits, kilobits, megabytes, etc.) of data during a given period, whereas the second memory region MR2 is written with Y data units during the same period. The write ratio may be expressed as X:Y, wherein X and Y may be greater than or equal to 0. In an exemplary embodiment, the write ratio manager 111 controls the memory MEM to write the write data to the first and second memory regions MR1 and MR2 that are mixed at the adjusted write ratio. In an embodiment, the controller 110 or the write ratio manager 111 may be implemented by a processor.

In an exemplary embodiment, the storage device 100 is an internal memory embedded in an electronic device. For example, the storage device 100 may be a universal flash storage (UFS) memory device, an embedded multimedia card (eMMC), or a solid state drive (SSD). In an exemplary embodiment, the storage device 100 is an external memory that is configured to be removable from an electronic device. For example, the storage device 100 may include at least one selected from among a UFS memory card, a compact flash (CF) card, a secure digital (SD) card, a micro secure digital (micro-SD) card, a mini secure digital (mini-SD) card, an extreme digital (xD) card, and a memory stick.

However, embodiments of the inventive concept are not limited to implementations of the storage device described above. For example, embodiments of the inventive concept may be applied to a cache memory including a high-speed memory (for example, SRAM) and a low-speed memory (for example, DRAM). In this case, a processor, such as a central processing unit (CPU), may dynamically adjust the write ratio of the high-speed memory to the low-speed memory based on a type of a currently running application or an operation environment.

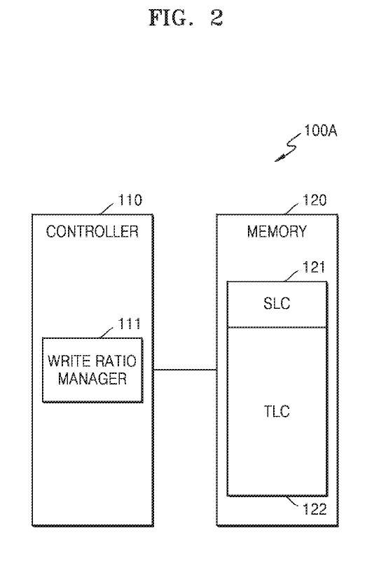

FIG. 2 is a block diagram illustrating an example 100A of the storage device 100 of FIG. 1, according to an embodiment.

Referring to FIG. 2, the storage device 100A includes a controller 110 and a memory 120, and the memory 120 includes an SLC region 121 and a TLC region 122. The SLC region 121 may correspond to an example of the first memory region MR1 (“MEM_REG1”) of FIG. 1, and the TLC region 122 may correspond to an example of the second memory region MR2 (“MEM_REG2”) of FIG. 1. However, embodiments of the inventive concept are not limited thereto. The second memory region MR2 included in the memory 120 may be an MLC region. The SLC region 121 includes a plurality of SLCs each configured to store 1-bit data, and the TLC region 122 includes a plurality of TLCs each configured to store 3-bit data. A first write speed of the SLC region 121 is faster than a second write speed of the TLC region 122.

In a present exemplary embodiment, a mixed write operation is performed on the SLC region 121 and the TLC region 122 based on a difference in a write speed between the SLC region 121 and the TLC region 122. In an embodiment, a write ratio manager 111 dynamically adjusts a write ratio of the SLC region 121 to the TLC region 122 according to requirements of the host 200 or internal determination by the storage device 100A, and data is stored in the SLC region 121 and the TLC region 122 that are mixed at the write ratio. As such, a consuming speed of the SLC region 121 may be controlled by dynamically adjusting the write ratio. Thus, it is possible to control the performance, lifetime, and buffer size of the storage device 100A.

Specifically, if the write ratio of the SLC region 121 to the TLC region 122 is increased in the mixed write operation, a larger amount of data may be written to the SLC region 121 having a faster write speed. Therefore, while an overall write performance (i.e., a write speed) of the storage device 100A is improved, the SLC region 121 is quickly consumed. Hence, an operation of migration of data from the SLC region 121 to the TLC region 122 is performed at an earlier time point. Consequently, the lifetime of the SLC region 121 is reduced, resulting in a reduction in the lifetime of the storage device 100A. Accordingly, in the present embodiment, the write ratio is dynamically adjusted to provide a desired performance, buffer size, and lifetime, and the write data is written to the SLC region 121 and the TLC region 122 that are mixed at the adjusted write ratio.

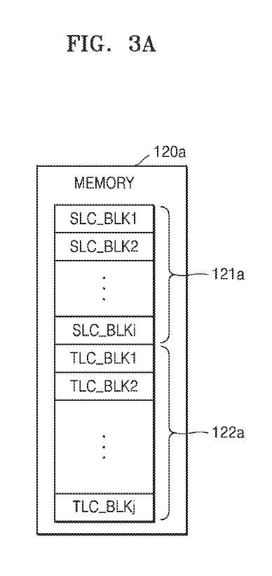

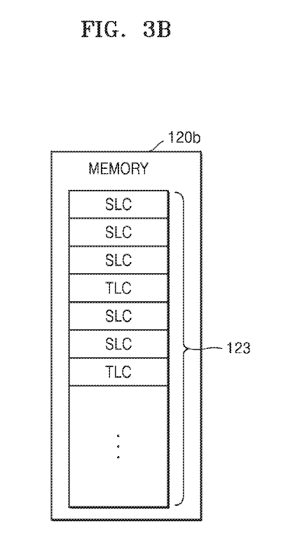

FIG. 3A illustrates an example 120a of the memory 120 of FIG. 2, and FIG. 3B illustrates another example 120b of the memory 120 of FIG. 2.

Referring to FIG. 3A, the memory 120a includes an SLC region 121a and a TLC region 122a. The SLC region 121a includes a plurality of SLC blocks SLC_BLK1 to SLC_BLKi, and the TLC region 122a includes a plurality of TLC blocks TLC_BLK1 to TLC_BLKj. Referring to FIG. 3B, the memory 120b may include a plurality of blocks 123. In some embodiments, the blocks 123 may be SLC blocks and/or TLC blocks. FIG. 3B shows an example where every four blocks includes three SLC blocks and a single TLC block.

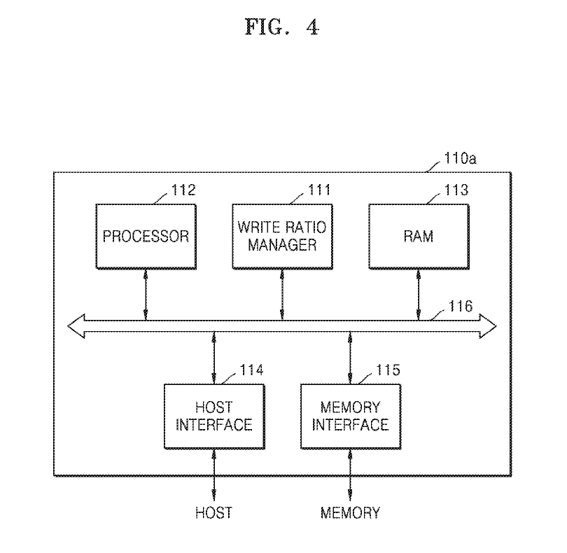

FIG. 4 is a block diagram illustrating an example 110a of the controller 110 of FIG. 2.

Referring to FIG. 4, the controller 110a includes a write ratio manager 111, a processor 112, RAM 113, a host interface 114, and a memory interface 115, which communicate with one another via a bus 116. The processor 112 may include a CPU or a microprocessor and may control an overall operation of the controller 110a. The RAM 113 may operate according to the control of the processor 112. The RAM 113 may be used as a work memory, a buffer memory, or a cache memory. In the present embodiment, data that the write ratio manager 111 requires for performing a write ratio adjustment operation may be loaded into the RAM 113. The host interface 114 may provide an interface between the host (e.g., 200 in FIG. 1) and the controller 110a, and the memory interface 115 may provide an interface between the controller 110a and the memory 120.

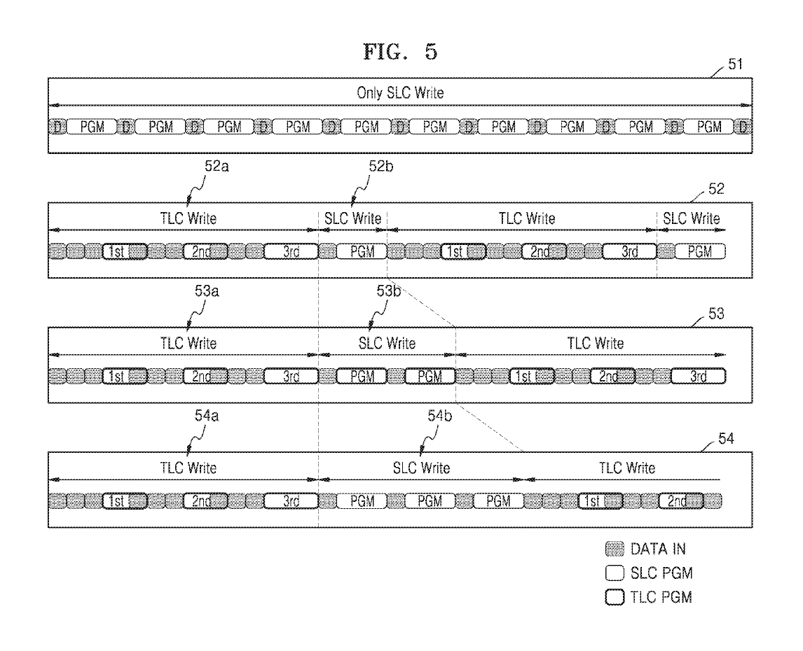

Referring to FIGS. 2 and 4, the write ratio manager 111 manages the write ratio of the SLC region 121 to the TLC region 122 included in the memory 120. Specifically, the write ratio manager 111 may dynamically adjust the write ratio according to requirements of the host and/or an internal determination by the storage device 100A. The write ratio manager 111 may be implemented by hardware, software, or firmware and may be driven based on data located within the RAM 113. Hereinafter, the operation of the write ratio manager 111 will be described in detail with reference to FIGS. 5 to 7C.

FIG. 5 illustrates an SLC write operation and mixed write operations that are performed on the memory 120 of FIG. 2 at a plurality of write ratios, according to an embodiment of the inventive concept.

Referring to FIGS. 2 and 5, an SLC write operation 51 corresponds to a case where a write ratio of the SLC region 121 to the TLC region 122 is 1:0. In this case, the write data is all stored in only the SLC region. The SLC write operation 51 includes data input sections D and data program sections PGM that alternate and repeat. The data input section D is a section where data is input from the controller 110 to the memory 120. In an embodiment, the memory 120 may further include a page buffer, and during the data input section D, the data input from the controller 110 may be stored in the page buffer. In particular, the data input from the controller 110 may be stored in a cache latch included in the page buffer. The data program section PGM is a section where the data input to the memory 120 is programmed into the SLC region 121. For example, during the data program section PGM, the data stored in the page buffer may be programmed into the SLC region 121. The write data may be divided into a plurality of pieces of partial data by the controller 110, and the pieces of partial data may be transferred from the controller 110 to the memory 120 at each data input section D.

A first mixed write operation 52 corresponds to a case where a write ratio of the SLC region 121 to the TLC region 122 is X1:Y, wherein X1 and Y are integers greater than or equal to 1. In this case, the write data is stored in the SLC region 121 and the TLC region 122 that are mixed at a ratio of X1:Y. The first mixed write operation 52 includes TLC write sections 52a and SLC write sections 52b that alternate and repeat. That is, when the TLC write section 52a ends, the SLC write section 52b may start. Then, when the SLC write section 52b ends, the TLC write section 52a may start. In this regard, switching between the TLC write section 52a and the SLC write section 52b may be performed in word line units. Therefore, after programming of memory cells connected to one word line included in the TLC region 122 ends, programming of memory cells connected to one word line included in the SLC region 121 may start.

Specifically, the TLC write section 52a is a section that stores data in the TLC region 122, and the SLC write section 52b is a section that stores data in the SLC region 121. During the TLC write section 52a, a 3-bit data input, a first program of storing first bit data, a 3-bit data input, a second program of storing second bit data, a 3-bit data input, and a third program of storing third bit data may be sequentially performed. On the other hand, during the SLC write section 52b, a single bit data input and a program of storing single bit data may be sequentially performed.

A second mixed write operation 53 corresponds to a case where a write ratio of the SLC region 121 to the TLC region 122 is X2:Y, wherein X2 and Y are integers greater than or equal to 1 and X2 is greater than X1. In this case, the write data is stored in the SLC region 121 and the TLC region 122 that are mixed at a ratio of X2:Y. The second mixed write operation 53 includes TLC write sections 53a and SLC write sections 53b that alternate and repeat. The TLC write section 53a may be substantially the same as the TLC write section 52a, and a larger amount of data may be programmed during the SLC write section 53b than during the SLC write section 52b.

A third mixed write operation 54 corresponds to a case where a write ratio of the SLC region 121 to the TLC region 122 is X3:Y, wherein X3 and Y are integers greater than or equal to 1 and X3 is greater than X2. In this case, the write data is stored in the SLC region 121 and the TLC region 122 that are mixed at a ratio of X3:Y. The third mixed write operation 54 includes TLC write sections 54a and SLC write sections 54b that alternate and repeat. The TLC write section 54a may be substantially the same as the TLC write section 53a, and a larger amount of data may be programmed during the SLC write section 54b than during the SLC write section 53b.

According to the present embodiment, the write ratio manager 111 adjusts the write ratio in real time according to requirements of the host and/or an internal determination by the storage device 100A. Therefore, one of the SLC write operation 51 and the first to third mixed write operations 52 to 54 may be selected. However, embodiments of the inventive concept are not limited thereto. In an embodiment, the write ratio manager 111 adjusts the write ratio of the SLC region 121 to the TLC region 122 to be 0:1. In this case, the write data is stored in only the TLC region 122. In an embodiment, the write ratio manager 111 can select one write operation among write operations 51 to 54 and the write operation described above that causes the write data to only be stored in the TLC region 122.

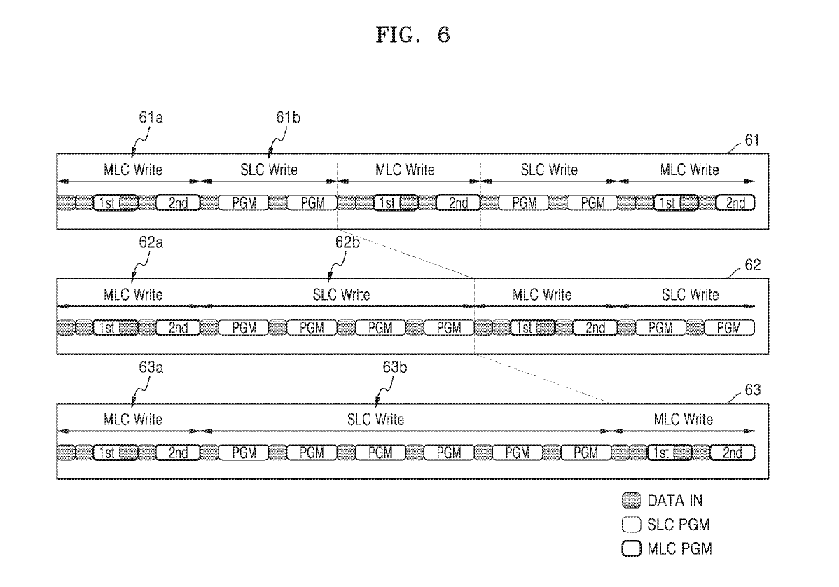

FIG. 6 illustrates mixed write operations at a plurality of write ratios, according to an embodiment of the inventive concept. Specifically, FIG. 6 illustrates mixed write operations when the storage device 100A of FIG. 2 includes an MLC region instead of the TLC region 122.

Referring to FIG. 6, a first mixed write operation 61 corresponds to a case where a write ratio of the SLC region to the MLC region is X1:Y, wherein X1 and Y are integers greater than or equal to 1. In this case, the write data is stored in the SLC region and the MLC region that are mixed at a ratio of X1:Y. The first mixed write operation 61 includes MLC write sections 61a and SLC write sections 61b that alternate and repeat. That is, when the MLC write section 61a ends, the SLC write section 61b may start. Then, when the SLC write section 61b ends, the MLC write section 61a may start. In this regard, switching between the MLC write section 61a and the SLC write section 61b may be performed in word line units. Therefore, after programming of memory cells connected to one word line included in the MLC region ends, programming of memory cells connected to one word line included in the SLC region may start. Specifically, the MLC write section 61a is a section that stores data in the MLC region, and the SLC write section 61b is a section that stores data in the SLC region. During the MLC write section 61a, a 2-bit data input, a first program of storing first bit data, a 2-bit data input, and a second program of storing second bit data may be sequentially performed. On the other hand, during the SLC write section 61b, a single bit data input and a program of storing single bit data that alternate and repeat may be performed.

A second mixed write operation 62 corresponds to a case where a write ratio of the SLC region to the MLC region is X2:Y, wherein X2 and Y are integers greater than or equal to 1 and X2 is greater than X1. In this case, the write data may be stored in the SLC region and the MLC region that are mixed at a ratio of X2:Y. The second mixed write operation 62 includes MLC write sections 62a and SLC write sections 62b that alternate and repeat. The MLC write section 62a may be substantially the same as the MLC write section 61a, and a larger amount of data may be programmed during the SLC write section 62b than during the SLC write section 61b.

A third mixed write operation 63 corresponds to a case where a write ratio of the SLC region to the MLC region is X3:Y, wherein X3 and Y are integers greater than or equal to 1 and X3 is greater than X2. In this case, the write data may be stored in the SLC region and the MLC region that are mixed at a ratio of X3:Y. The third mixed write operation 63 may include MLC write sections 63a and SLC write sections 63b that alternate and repeat. The MLC write section 63a may be substantially the same as the MLC write section 62a, and a larger amount of data may be programmed during the SLC write section 63b than during the SLC write section 62b.

According to the present embodiment, the write ratio manager 111 may adjust the write ratio in real time according to requirements of the host and/or internal determination by the storage device. Therefore, one of the SLC write operation and the first to third mixed write operations 61 to 63 may be selected. However, embodiments of the inventive concept are not limited thereto. The write ratio manager may adjust the write ratio of the SLC region to the MLC region to be 0:1. In this case, the write data is stored in only the MLC region. In an embodiment, the write ratio manager 111 can select one write operation among write operations 61 to 63 and the write operation described above that causes the write data to only be stored in the MLC region.

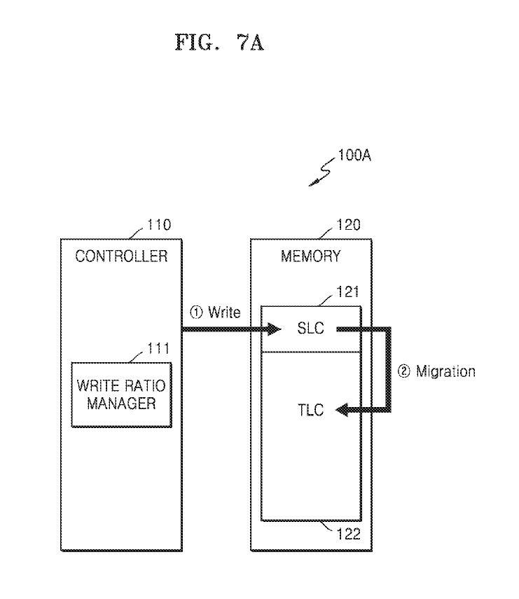

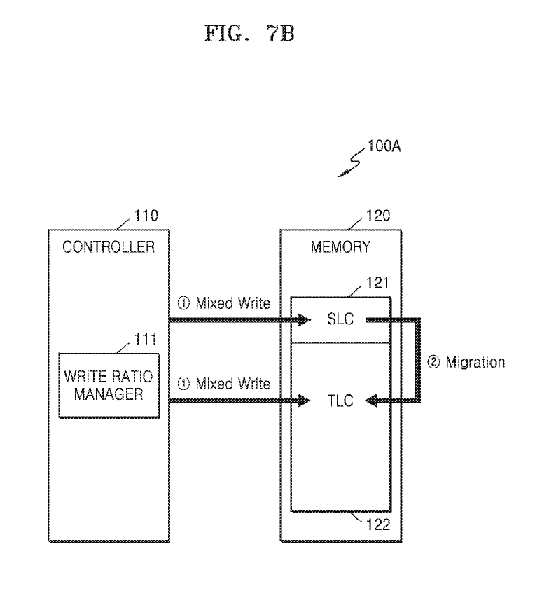

FIGS. 7A and 7B respectively illustrate the SLC write operation 51 and the first to third mixed write operations 52 to 54 of FIG. 5, according to an embodiment of the inventive concept.

Referring to FIG. 7A, in the case of the SLC write operation 51 of FIG. 5, the write data is all stored in the SLC region 121 at a fast speed. Then, the data stored in the SLC region 121 is migrated to the TLC region 122. In an embodiment, the migration operation is performed when an empty space of the SLC region 121 is greater than or equal to a preset space (e.g., 30%). If the data stored in the SLC region 121 is migrated to the TLC region 122, the data stored in the SLC 121 may be invalid data and may be deleted from the SLC region 121 by an erase operation, so that an empty space is secured in the SLC region 121. Thus, write data received subsequently may be all stored in the SLC region 121 at a fast speed. Hence, the SLC region 121 may be also referred to as a cache region, and the TLC region 122 may also be referred to as a main region.

Due to the migration operation, the write data stored in the SLC region 121 may be stored again in the TLC region 122. Therefore, since the amount of data actually written to the memory 100A is increased as compared to the amount of data received from the host, a write amplification factor (WAF) may be increased. Also, since the same data is redundantly written to the SLC region 121 and the TLC region 122, power consumption may be increased. Furthermore, if an empty space is secured in the SLC region 121 by the migration operation, data is stored again in the SLC region 121. Hence, a program/erase cycle count for the SLC region 121 may be increased.

Therefore, when the SLC write operation is performed, the write performance of the storage device 100A is very high due to a fast write speed with respect to the SLC region 121. However, a section capable of maintaining constant high performance is short and a buffer size capable of providing constant high performance is small. Also, the increase in the program/erase cycle count for the SLC region 121 may reduce the lifetime of the storage device 100A.

Referring to FIG. 7B, in the case of the first to third mixed write operations 52 to 54 of FIG. 5, the write data is mixedly written to the SLC region 121 and the TLC region 122. Specifically, the write data is divided into a plurality of pieces of partial data, and the plurality of pieces of partial data are sequentially output to the controller 110 and then alternately stored in the SLC region 121 and the TLC region 122. Then, the data stored in the SLC region 121 is migrated to the TLC region 122.

According to the present embodiment, since pieces of the write data are mixedly written to the SLC region 121 and the TLC region 122, the amount of data written to the SLC region 121 may be reduced as compared to the SLC write operation of FIG. 7A. Thus, a consuming speed of the SLC region 121 may decrease as compared to the SLC write operation of FIG. 7A. Therefore, a migration execution time point may be delayed as compared to the SLC write operation of FIG. 7A. Thus, the WAF and power consumption may be reduced, and the program/erase cycle count for the SLC region 121 may be performed at a slower speed.

Therefore, when the mixed write operation is performed, the write performance of the storage device 100A is low, as compared to that in FIG. 7A, but may be maintained to be high, as compared to the TLC write operation of writing data to only the TLC region 122, due to a mixture of a relatively fast write speed of the SLC region 121 and a relatively slow write speed of the TLC region 122. Also, the section where the storage device 100A can maintain the constant performance is longer than that in FIG. 7A, and the buffer size that can provide the constant performance is large as compared to that in FIG. 7A. Furthermore, since the program/erase cycle count for the SLC region 121 may be performed at a slower speed, the lifetime of the SLC region 121 may increase, resulting in an increase in the lifetime of the storage device 100A.

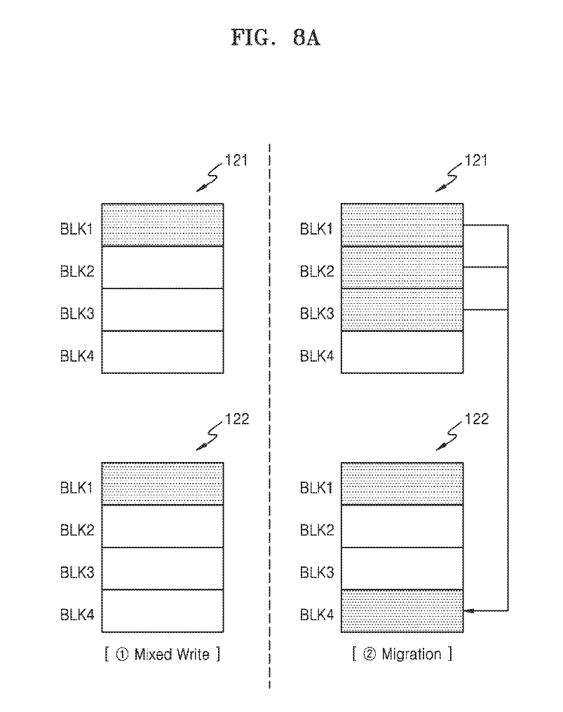

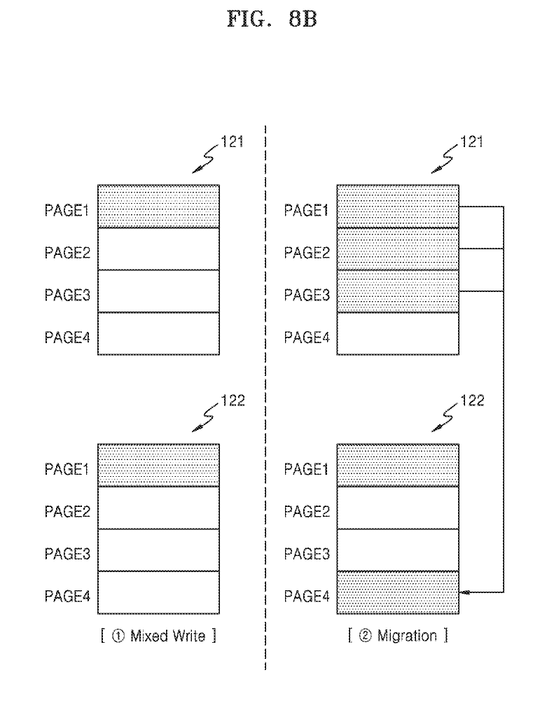

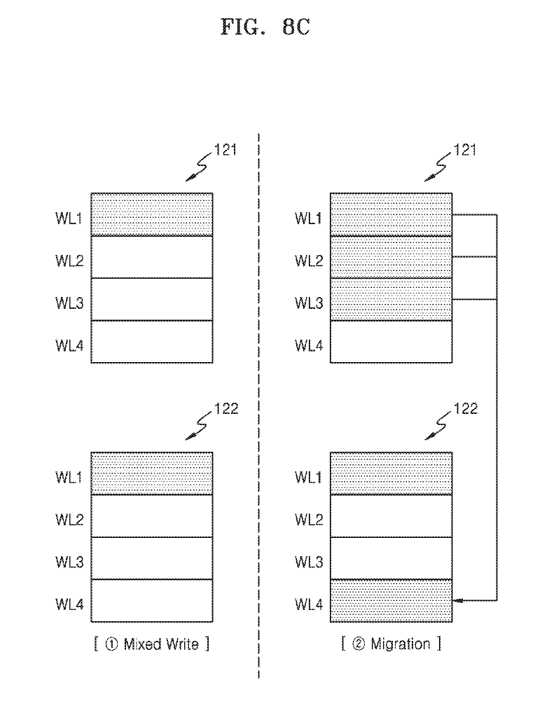

FIGS. 8A to 8C illustrate mixed write operations and migration operations, according to some embodiments of the inventive concept.

Referring to FIG. 8A, the mixed write operation is performed in block units of the SLC region 121 and the TLC region 122. In the TLC write section (e.g., 52a in FIG. 5), data is stored in a first block BLK1 of the TLC region 122. Then, in the SLC write section (e.g., 52b in FIG. 5), next data is stored in a first block BLK1 of the SLC region 121. Then, in the TLC write section, data is stored in a second block BLK2 of the TLC region 122. In the SLC write section, data is stored in a second block BLK2 of the SLC region 121. As such, the TLC write operation and the SLC write operation may be alternately performed in block units, and data stored in the SLC region 121 may be migrated to some blocks (e.g., BLK4) of the TLC region 122 at a migration time point.

Referring to FIG. 8B, the mixed write operation is performed in page units of the SLC region 121 and the TLC region 122. In the TLC write section (e.g., 52a in FIG. 5), data is stored in a page block PAGE1 of the TLC region 122. Then, in the SLC write section (e.g., 52b in FIG. 5), next data is stored in a first page PAGE1 of the SLC region 121. Then, in the TLC write section, data is stored in a second page PAGE2 of the TLC region 122. In the SLC write section, data is stored in a second page PAGE2 of the SLC region 121. As such, the TLC write operation and the SLC write operation may be alternately performed in page units, and data stored in the SLC region 121 may be migrated to some pages (e.g., PAGE4) of the TLC region 122 at a migration time point.

Referring to FIG. 8C, the mixed write operation is performed in word line units of the SLC region 121 and the TLC region 122. In the TLC write section (e.g., 52a in FIG. 5), data is stored in memory cells connected to a first word line WL1 of the TLC region 122. Then, in the SLC write section (e.g., 52b in FIG. 5), next data is stored in memory cells connected to a first word line WL1 of the SLC region 121. Then, in the TLC write section, data is stored in memory cells connected to a second word line WL2 of the TLC region 122. In the SLC write section, data is stored in memory cells connected to a second word line WL2 of the SLC region 121. As such, the TLC write operation and the SLC write operation may be alternately performed in word line units, and data stored in the SLC region 121 may be migrated to some memory cells connected to some word lines (e.g., WL4) of the TLC region 122 at a migration time point.

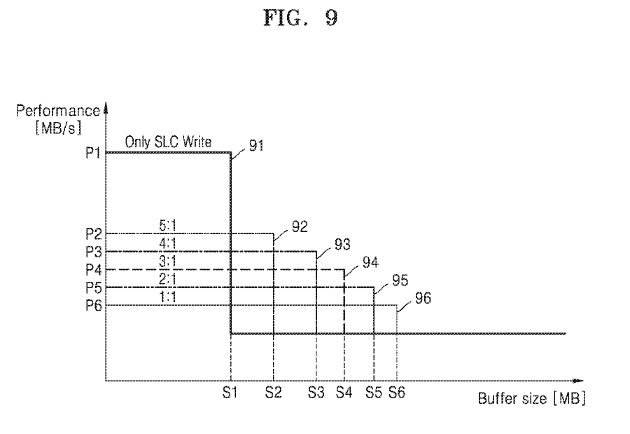

FIG. 9 is a graph showing a relationship between buffer size and performance when a write operation is performed at a plurality of write ratios, according to an embodiment of the inventive concept.

Referring to FIG. 9, the horizontal axis represents buffer size and the vertical axis represents performance. The buffer size is a use amount of the storage device 100A, that is, the amount of data stored in the storage device 100A, and may be expressed in units of megabytes MB. The performance may be the write performance (i.e., a write speed) of the storage device 100A and may be expressed in units of MB/s. Hereinafter, the relationship between the buffer size and the performance at different write ratios will be described in detail with reference to FIGS. 2 and 9.

When maximum performance is required according to the requirements of the host or the internal determination by the storage device 100A, the storage device 100A may adjust a write ratio to be 1:0 and perform an SLC write operation 91 of writing data to only the SLC region 121. In this case, the storage device 100A provides a first performance P1 while a use amount of the SLC region 121 is less than or equal to a first buffer size S1. However, a user may not always require maximum performance in practice. Nevertheless, if the write ratio is fixed to 1:0 and the SLC write operation 91 is performed, the lifetime of the storage device 100A may be reduced and the power consumption thereof may be increased. According to the present embodiment, when the performance is required to be less than the maximum performance, the storage device 100A dynamically adjusts the write ratio based on the required performance and performs mixed write operations 92 to 96.

In the case of the mixed write operation 92 with the write ratio of 5:1, the storage device 100A provides a second performance P2 that is lower than the first performance P1 while a use amount of the SLC region 121 and the TLC region 122 is less than or equal to a second buffer size S2. In the case of the mixed write operation 93 with the write ratio of 4:1, the storage device 100A provides a third performance P3 that is lower than the second performance P2 while a use amount of the SLC region 121 and the TLC region 122 is less than or equal to a third buffer size S3. In the case of the mixed write operation 94 with the write ratio of 3:1, the storage device 100A provides a fourth performance P4 that is lower than the third performance P3 until a use amount of the SLC region 121 and the TLC region 122 is less than or equal to a fourth buffer size S4. In the case of the mixed write operation 95 with the write ratio of 2:1, the storage device 100A provides a fifth performance P5 that is lower than the fourth performance P4 while a use amount of the SLC region 121 and the TLC region 122 is less than or equal to a fifth buffer size S5. In the case of the mixed write operation 96 with the write ratio of 1:1, the storage device 100A provides a sixth performance P6 that is lower than the fifth performance P5 while a use amount of the SLC region 121 and the TLC region 122 is less than or equal to a sixth buffer size S6.

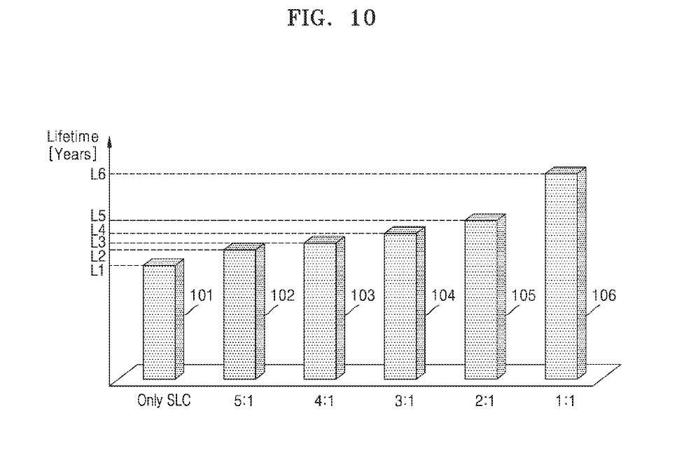

FIG. 10 is a graph showing a lifetime of a storage device at a plurality of write ratios, according to an embodiment of the inventive concept. Hereinafter, the lifetime of the storage device 100A at different write ratios will be described in detail with reference to FIGS. 2 and 10.

Referring to FIGS. 2 and 10, an SLC write operation 101 corresponds to a case where a write ratio of the SLC region 121 to the TLC region 122 is 1:0 and writes data to only the SLC region 121. Thus, the consumption of the SLC region 121 is fast and the migration from the SLC region 121 to the TLC region 122 is performed at an earlier time point. Accordingly, since a program/erase cycle count for the SLC region 121 rapidly increases, the lifetime of the SLC region 121 may be the shortest (L1) and thus the lifetime of the storage device 100A may be the shortest.

Mixed write operations 102 to 106 correspond to cases where a write ratio of the SLC region 121 to the TLC region 122 is 5:1, 4:1, 3:1, 2:1, and 1:1, respectively, and write data to the SLC region 121 and the TLC region 122. Thus, as compared to the SLC write operation 101, the consumption of the SLC region 121 is slow and the migration from the SLC region 121 to the TLC region 122 is performed at a later time point. Accordingly, since a program/erase cycle count for the SLC region 121 slowly increases, the lifetime of the SLC region 121 is longer than L1. As the amount of data written to the SLC region 121 among all the write data is reduced, that is, as the write ratio is increased from 5:1 to 1:1, the lifetime of the SLC region 121 may increase, resulting in an increase in the lifetime of the storage device 100A. Therefore, according to the present embodiment, the write ratio manager 111 may dynamically adjust the write ratio according to the requirements of the host or the internal determination by the storage device 100A, thereby increasing the lifetime of the storage device 100A.

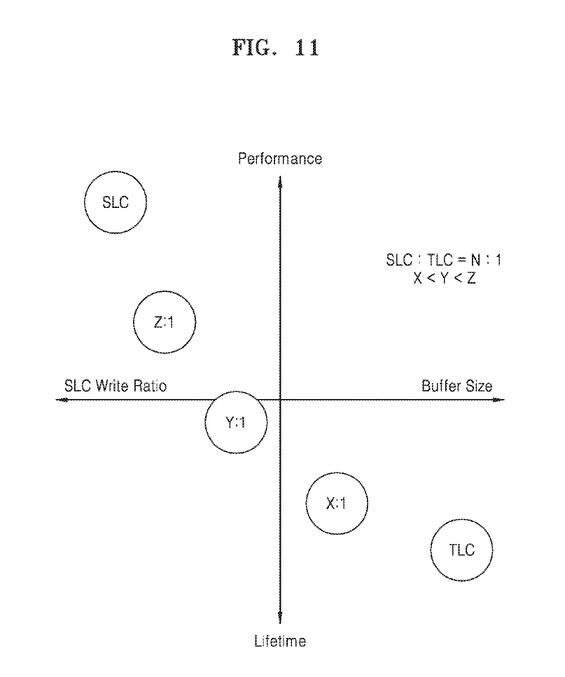

FIG. 11 is a graph showing performance, buffer size, and lifetime of the storage device at a plurality of write ratios, according to an embodiment of the inventive concept. Hereinafter, the performance, the buffer size, and the lifetime of the storage device 100A at different write ratios will be described in detail with reference to FIGS. 2 and 11.

Referring to FIGS. 2 and 11, in the case of an SLC write mode in which a write ratio of the SLC region 121 to the TLC region 122 is 1:0, the performance of the storage device 100A is highest, but the buffer size thereof is smallest and the lifetime thereof is shortest. In the case of a mixed write mode in which a write ratio of the SLC region 121 to the TLC region 122 is N:1, as N is reduced (that is, the write ratio is reduced from Z:1 to X:1, the performance of the storage device 100A is reduced, but the buffer size and the lifetime thereof may be increased. On the other hand, in the case of a TLC write mode in which a write ratio of the SLC region 121 to the TLC region 122 is 0:1, the performance of the storage device 100A is lowest, but the buffer size thereof is largest and the lifetime thereof is longest.

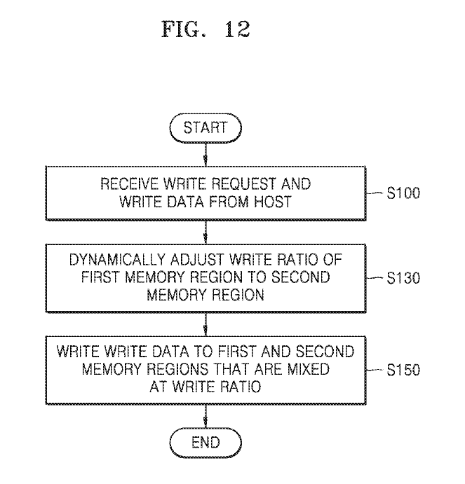

FIG. 12 is a flowchart of a method of operating a storage device, according to an exemplary embodiment of the inventive concept.

Referring to FIG. 12, the method of operating a storage device, according to the present embodiment, may be an operation of writing data to the storage device and may include, for example, operations performed in time series by the storage device 100 of FIG. 1. The descriptions provided with reference to FIGS. 1 to 11 may be applied to the present embodiment, and redundant descriptions will be omitted. Hereinafter, the method of operating a storage device will be described in detail with reference to FIGS. 1, 4, and 12.

In operation S100, a write request and write data are received from the host 200. Specifically, the host interface 114 may receive the write request and the write data from the host 200. In this case, a size of the write data and a frequency of the write request may be different according to a type of a currently running application or an operation environment of the host 200. For example, when a camera application is executed in the host 200, the host 200 may provide the write request and the write data to the storage device 100 so as to store data generated by a photographing operation therein. In this case, the size of the write data may be very large and the frequency of the write request may be relatively high.

In operation S130, a write ratio of the first memory region MR1 to the second memory region MR2 is dynamically adjusted for the write data. In this case, the first memory region MR1 may include memory cells having a first write speed, and the second memory region MR2 may include memory cells having a second write speed that is different from the first write speed. Specifically, the write ratio manager 111 may dynamically adjust the write ratio based on the requirements of the host 200, the size of the write data, the frequency of the write request, and/or state information of the first and second memory regions MR1 and MR2.

In an embodiment, the write ratio manager 111 adjusts the write ratio based on mode information received from the host 200. In an embodiment, the write ratio manager 111 selects a particular write ratio by using the mode information to access a table stored in the RAM 113. For example, the table may include a plurality of entries, where each entry includes a different mode number and write ratio, and the mode information includes a mode number that corresponds to one of the entries. In an embodiment, the write ratio manager 111 adjusts the write ratio at regular time intervals. For example, the write ratio manager 111 may periodically determine whether to adjust the write ratio, and then upon determine that a change is needed, change the current write ratio to a new and different write ratio. In an embodiment, the write ratio manager 111 adjusts the write ratio in real time during the write operation. In an embodiment, the write ratio manager 111 adjusts the write ratio when the write data buffered in the RAM 113 exceeds a reference capacity. In an embodiment, the write ratio manager 111 adjusts the write ratio when a temperature of the storage device 100 is outside a reference range. In an embodiment, the write ratio manager 111 selects a write ratio that relies more on the TLC region when the temperature is above a threshold value. For example, if the write ratio of the SLC region 121 to the TLC region 122 is 1:0 , and the temperature suddenly exceeds the threshold value, the write ratio manager 111 could adjust the write ratio to 5:1 or 4:1.

In operation S150, the write data is written to the first and second memory regions MR1 and MR2 that are mixed at the adjusted write ratio. Specifically, the memory interface 115 may sequentially output partial data divided from the write data and may control the storage device 100 to alternately write the sequentially output partial data to the first and second memory regions MR1 and MR2.

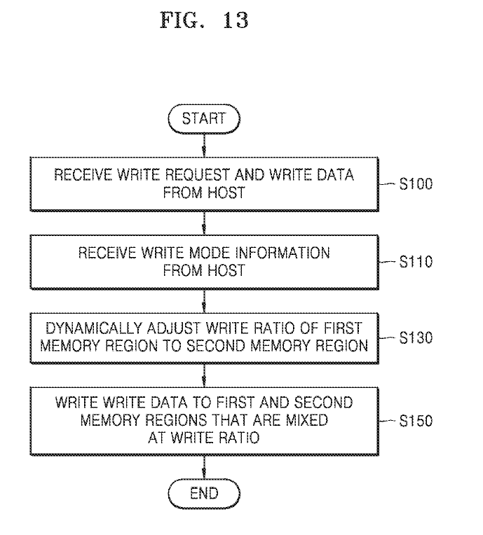

FIG. 13 is a flowchart of a method of operating a storage device, according to an exemplary embodiment of the inventive concept.

Referring to FIG. 13, the operating method according to the present embodiment may correspond to an implementation example of the method of FIG. 12. Specifically, the operating method according to the present embodiment may further include operation S110 in the method of FIG. 12. Hereinafter, the operating method according to the present embodiment will be described with reference to FIGS. 1 and 13, focusing on differences from the method of FIG. 12.

In operation S100, a write request and write data are received from the host 200. In operation S110, write mode information is received from the host 200. The write mode information may be information for adjusting a write ratio of the first memory region MR1 to the second memory region MR2. In an embodiment, the write mode information includes a write mode indicating the write ratio. However, embodiments of the inventive concept are not limited thereto. The write mode information may be a maximum performance desired by the host 200, a lifetime, a buffer size, and the like. In an embodiment, operations S100 and S110 are performed substantially at the same time, and the storage device 100 receives the write request, the write data, and the write mode information from the host 200. For example, the host 200 may send a message to the storage device 100 that includes the write request (e.g., a write command, write data, and the write mode information). However, embodiments of the inventive concept are not limited thereto. Operation S110 may be performed prior to operation S100.

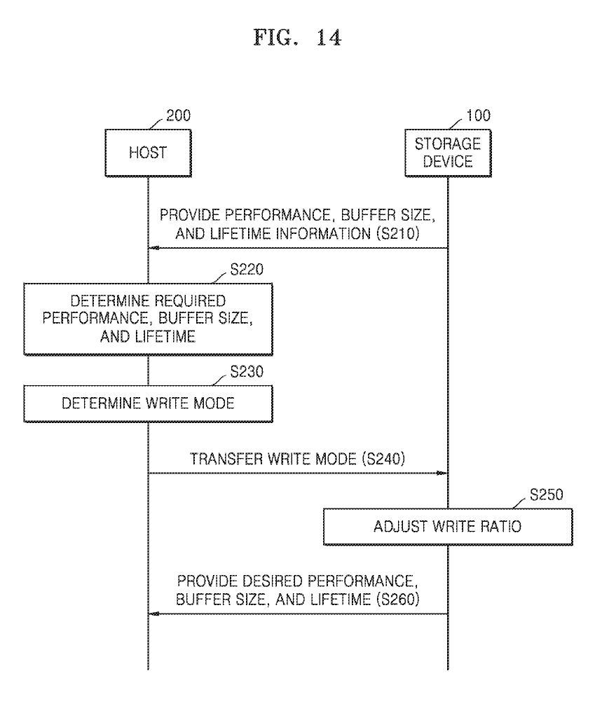

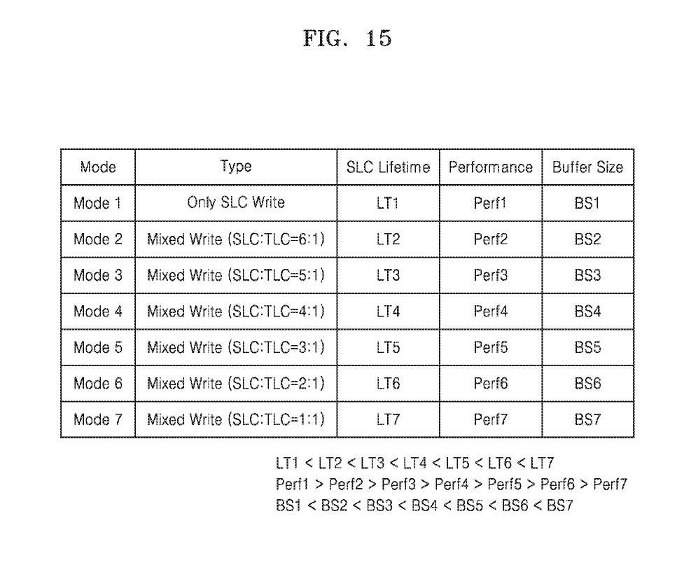

In operation S130, a write ratio of the first memory region MR1 to the second memory region MR2 is dynamically adjusted for the write data. Specifically, the write ratio manager 111 may dynamically adjust the write ratio based on the write mode information and provide a storage environment desired by the host 200. In operation S150, the write data is written to the first and second memory regions MR1 and MR2 that are mixed at the adjusted write ratio. Hereinafter, the operation of adjusting the write ratio according to the requirements of the host 200, according to the present embodiment, will be described in detail with reference to FIGS. 14 and 15.

FIG. 14 is a flowchart of an operation between the host 200 and the storage device 100, according to an exemplary embodiment of the inventive concept. FIG. 15 is a table showing an example of information provided in operation S210 of FIG. 14.

Referring to FIGS. 14 and 15, in operation S210, the storage device 100 provides at least one of the performance, buffer size, and lifetime information of the storage device 100 to the host 200. In an embodiment, the storage device 100 provides the table of FIG. 15 to the host 200. For example, the first memory region MR1 may be an SLC region and the second memory region MR2 may be a TLC region. The term “mode” used herein indicates various modes that may be selected by the host 200. The term “type” used herein indicates an SLC write or a mixed write according to various write ratios. The term “SLC lifetime” used herein indicates a lifetime of the SLC region that is expected in each mode. The term “performance” used herein indicates a write performance (i.e., a write speed) of the storage device 100 that is expected in each mode. The term “buffer size” used herein indicates a storage space of the storage device 100 that is expected in each mode.

Mode 1 indicates an SLC write mode in which a write ratio of the SLC region to the TLC region is 1:0, and modes 2 to 7 indicate mixed write modes in which a write ratio of the SLC region to the TLC region is N:1. As a ratio of the amount of data written to the SLC region to all the write data is reduced, that is, as the mode is changed from mode 1 to mode 7, the SLC lifetime increases (i.e., LT1<LT2<LT3<LT4<LT5<LT6<LT7), the performance decreases (i.e, Perf1>Perf2>Perf3>Perf4>Perf5>Perf6>Perf7), and the buffer size increases (i.e., BS1<BS2<BS3<BS4<BS5<BS6<BS7).

In operation S220, the host 200 determines at least one of the required performance, buffer size, and lifetime. Since the required performance, buffer size, and lifetime may be different according to a type of a currently running application or an operation environment of the host 200, the host 200 may determine at least one of the required performance, buffer size, and lifetime with respect to the current write request. In operation S230, the host 200 determines a write mode. The host 200 may determine the write mode based on the determined required performance, buffer size, and lifetime.

In operation S240, the host 200 transfers the write mode to the storage device 100. For example, the host 200 may transfer one of modes 1 to 7 of FIG. 15 to the storage device 100 as the write mode. However, embodiments of the inventive concept are not limited thereto. The host 200 may transfer a TLC write mode of storing data in only the TLC region to the storage device 100. In an embodiment, the host 200 transfers the write mode to the storage device 100 together with the write request and the write data. In an embodiment, the host 200 transfers the write mode to the storage device 100 after transferring the write request and the write data to the storage device 100. In an embodiment, the host 200 transfers the write request and the write data to the storage device 100 after transferring the write mode to the storage device 100.

In operation S250, the storage device 100 adjusts a write ratio. The storage device 100 dynamically adjusts the write ratio of the first memory region MR1 to the second memory region MR2 based on the received write mode. In operation S260, the storage device 100 provides at least one of desired performance, buffer size, and lifetime to the host 200.

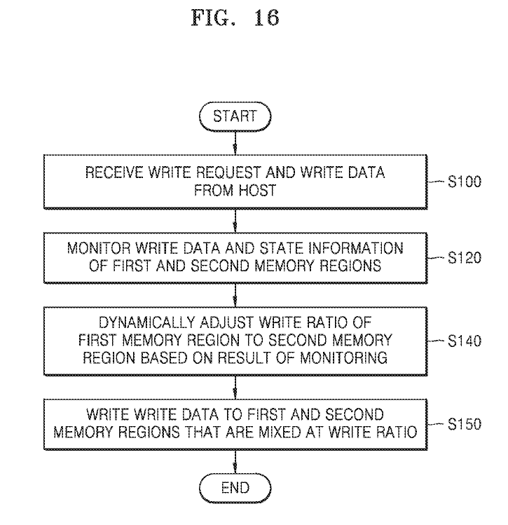

FIG. 16 is a flowchart of a method of operating a storage device, according to an exemplary embodiment of the inventive concept.

Referring to FIG. 16, the operating method according to the present embodiment may correspond to an implementation example of the method of FIG. 12. Specifically, the operating method according to the present embodiment may further include operation S120 in the method of FIG. 12. Hereinafter, the operating method according to the present embodiment will be described with reference to FIGS. 1 and 16, focusing on differences from the method of FIG. 12.

In operation S100, a write request and write data are received from the host 200. In operation S120, the write data and state information of the first and second memory regions MR1 and MR2 are monitored. In an embodiment, the write ratio manager 111 monitors a size of the write data and a frequency of the write request. In an embodiment, state information of the first and second memory regions MR1 and MR2 may include a program/erase cycle count with respect to each of the first and second memory regions MR1 and MR2, the number of free blocks of each of the first and second memory regions MR1 and MR2, and a data retention time of each of the first and second memory regions MR1 and MR2. For example, the write ratio manager 111 may select a write ratio that relies more on the TLC region when the program/erase cycle count exceeds a threshold count or when the data retention time is less than the threshold time. For example, if the write ratio of the SLC region 121 to the TLC region 122 is 1:0, and the program/erase cycle exceeds the threshold count or the data retention time is less than the threshold time, the write ratio manager 111 could adjust the write ratio to 5:1 or 4:1. The data retention time may be calculated based on the age of the memory device.

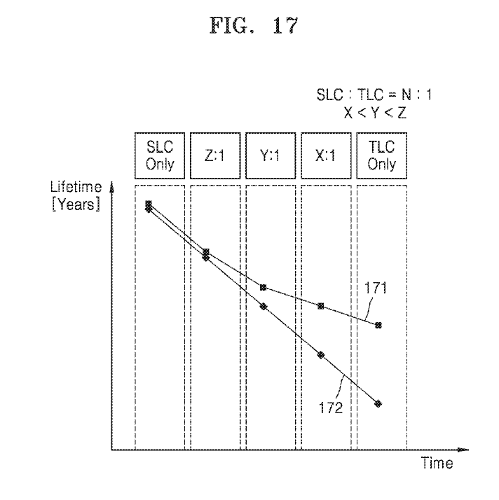

In operation S140, a write ratio of the first memory region MR1 to the second memory region MR2 is dynamically adjusted based on a result of the monitoring. Specifically, the write ratio manager 111 may control the performance, the buffer size, and the lifetime of the storage device 100 by dynamically adjusting the write ratio based on the result of the monitoring. In operation S150, the write data is written to the first and second memory regions MR1 and MR2 that are mixed at the adjusted write ratio. Hereinafter, operation S140 of dynamically adjusting the write ratio based on the result of the monitoring will be described in more detail with reference to FIG. 17.

FIG. 17 is a graph showing a lifetime of a storage device when a write ratio changes with time, according to an embodiment of the inventive concept. Hereinafter, a change in the lifetime of the storage device will be described in detail with reference to FIGS. 2 and 17.

Referring to FIG. 17, the horizontal axis represents the time and the vertical axis represents the lifetime. In the case of an SLC write mode 172 of writing data to only the SLC region 121, the lifetime is reduced at a constant ratio over time. According to the present embodiment, the write ratio manager 111 dynamically adjusts the write ratio based on the write data and the state information of the SLC region 121 and the TLC region 122. Accordingly, in the case of a mixed write mode 171 of writing data to the SLC region 121 and the TLC region 122 that are mixed at the write ratio, a lifetime reduction speed may be lower, as compared to the SLC write mode 172.

Specifically, the write ratio manager 111 may initially determine the write ratio of the SLC region 121 to the TLC region 122 to be 1:0 so as to write data to only the SLC region 121. Accordingly, the storage device 100A may provide the maximum performance. With the lapse of time, the number of repetitions of the write operation and the migration operation with respect to the SLC region 121 may increase and thus the program/erase cycle count for the SLC region 121 may approach a maximum value. In this regard, the write ratio manager 111 may adjust the write ratio in the order of Z:1, Y:1, and X:1 so as to reduce the ratio of data written to the SLC region 121 to all the write data (Z>Y>X). Also, with the lapse of time, the write ratio manager 111 may determine the write ratio to be 0:1 so as to write data entirely to the TLC region 122.

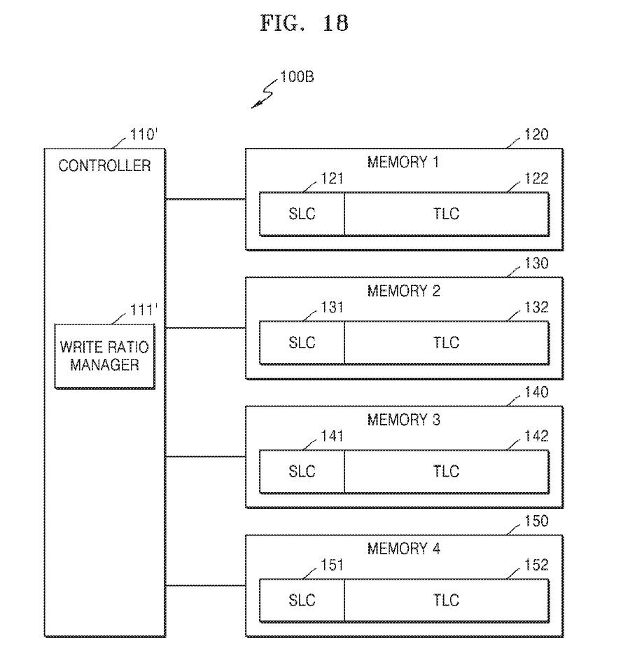

FIG. 18 is a block diagram illustrating another example 100B of the storage device 100 of FIG. 1, according to an exemplary embodiment of the inventive concept.

Referring to FIG. 18, the storage device 100B includes a controller 110′ and first to fourth memories 120 to 150, and the controller 110′ includes a write ratio manager 111′. The storage device 100B according to the present embodiment is a modified version of the storage device 100A of FIG. 2. Unlike the storage device 100A of FIG. 2, the storage device 100B includes a plurality of memories, namely, first to fourth memories 120 to 150, which may be respectively implemented by individual memory chips. In an embodiment, the first to fourth memories 120 to 150 (e.g., “MEM1”, “MEM2, “MEM3”, and “MEM4”) are connected to the controller 110′ through first to fourth channels, respectively. However, embodiments of the inventive concept are not limited thereto. For example, in an alternate embodiment, at least two of the first to fourth memories 120 to 150 share one channel with each other.

In the present embodiment, the first memory 120 includes an SLC region 121 and a TLC region 122, and the second memory 130 includes an SLC region 131 and a TLC region 132. Also, the third memory 140 includes an SLC region 141 and a TLC region 142, and the fourth memory 150 includes an SLC region 151 and a TLC region 152. In this case, the SLC regions 121, 131, 141, and 151 may correspond to an example of the first memory region MR1 of FIG. 1, and the TLC regions 122, 132, 142, and 152 may correspond to an example of the second memory region MR2 of FIG. 1. However, embodiments of the inventive concept are not limited thereto. At least one of the first to fourth memories 120 to 150 may include an MLC region instead of the TLC region. Also, at least one of the first to fourth memories 120 to 150 may further include an MLC region.

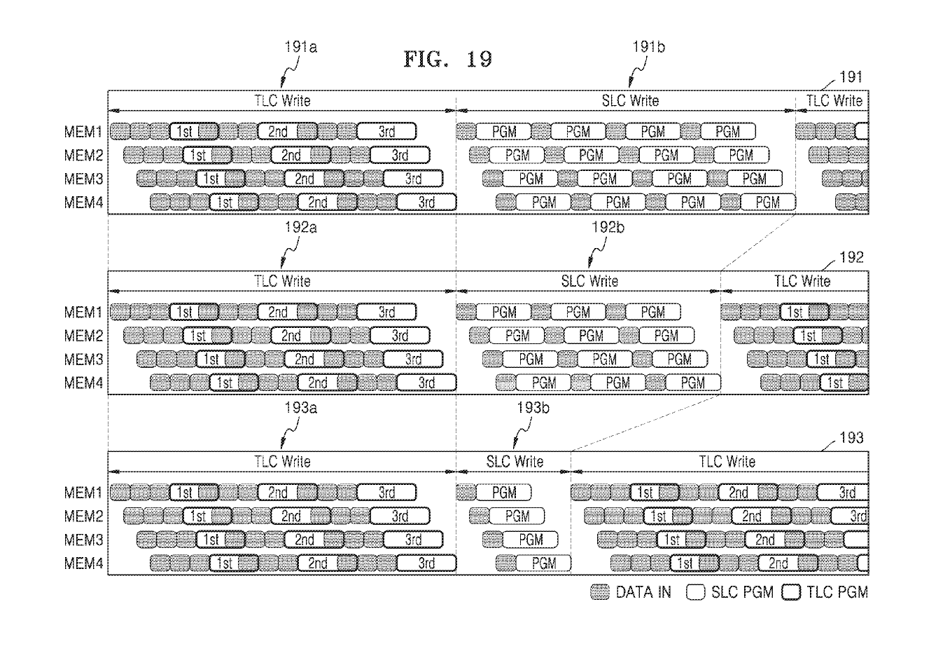

FIG. 19 illustrates first to third mixed write operations 191, 192, and 193 with respect to the first to fourth memories 120 to 150 of FIG. 18 at a plurality of write ratios, according to an exemplary embodiment of the inventive concept.

Referring to FIGS. 18 and 19, the first mixed write operation 191 may correspond to a case where a write ratio of the SLC regions 121, 131, 141, and 151 to the TLC regions 122, 132, 142, and 152 is X1:Y, wherein X1 and Y are integers greater than or equal to 1. In this case, the write data is stored in the SLC regions 121, 131, 141, and 151 and the TLC regions 122, 132, 142, and 152 that are mixed at the ratio of X1:Y. The first mixed write operation 191 includes TLC write sections 191a and SLC write sections 191b that alternate and repeat. In this regard, switching between the TLC write section 191a and the SLC write section 191b may be performed in word line units.

The TLC write section 191a is a section that stores data in the TLC regions 122, 132, 142, and 152, and the SLC write section 191b is a section that stores data in the SLC regions 121, 131, 141, and 151. In the TLC write section 191a, a 3-bit data input, a first program of storing first bit data, a 3-bit data input, a second program of storing second bit data, a 3-bit data input, and a third program of storing third bit data may be sequentially performed. In the SLC write section 191b, a single bit data input and a program of storing single bit data may be sequentially performed.

The second mixed write operation 192 may correspond to a case where a write ratio of the SLC regions 121, 131, 141, and 151 to the TLC regions 122, 132, 142, and 152 is X2:Y, wherein X2 and Y are integers greater than or equal to 1 and X2 is less than X1. In this case, the write data may be stored in the SLC regions 121, 131, 141, and 151 and the TLC regions 122, 132, 142, and 152 that are mixed at the ratio of X2:Y. The second mixed write operation 192 may include TLC write sections 192a and SLC write sections 192b that alternate and repeat. The TLC write section 192a may be substantially the same as the TLC write section 191a, and a smaller amount of data may be programmed in the SLC write section 192b than in the SLC write section 191b.

The third mixed write operation 193 may correspond to a case where a write ratio of the SLC regions 121, 131, 141, and 151 to the TLC regions 122, 132, 142, and 152 is X3:Y, wherein X3 and Y are integers greater than or equal to 1 and X3 is less than X2. In this case, the write data may be stored in the SLC regions 121, 131, 141, and 151 and the TLC regions 122, 132, 142, and 152 that are mixed at the ratio of X3:Y. The third mixed write operation 193 may include TLC write sections 193a and SLC write sections 193b that alternate and repeat. The TLC write section 193a may be substantially the same as the TLC write section 192a, and a smaller amount of data may be programmed in the SLC write section 193b than in the SLC write section 192b.

The writing of data that occurs with respect to the memories 120-150 during any one of the mixed write operations 191-193 may be staggered. In an embodiment, during the first mixed write operation 191, the writing to the TLC region 122 of the first memory 120 completes first, the writing to the TLC region 132 of the second memory 130 completes second, the writing to the TLC region 142 of the third memory 140 completes third, and the writing to the TLC region 152 of the fourth memory 150 completes fourth. In an embodiment, during the first mixed write operation 191, the writing to the SLC region 121 of the first memory 120 completes first after the writing to the TLC region 122 completes, the writing to the SLC region 131 of the second memory 130 completes second after the writing to the TLC region 132 completes, the writing to the SLC region 141 of the third memory 140 completes third after the writing to the TLC region 142 completes, and the writing to the SLC region 151 of the fourth memory 150 completes fourth after the writing to the TLC region 152 completes.

According to the present embodiment, the write ratio manager 111′ adjusts the write ratio in real time according to requirements of the host and/or an internal determination by the storage device 100B. Therefore, one of the SLC write operation and the plurality of mixed write operations including the first to third mixed write operations 191 to 193 may be selected. However, embodiments of the inventive concept are not limited thereto. For example, the write ratio manager 111′ may adjust the write ratio of the SLC regions 121, 131, 141, and 151 to the TLC regions 122, 132, 142, and 152 to be 0:1. In this case, the write data is stored in only the TLC regions 122, 132, 142, and 152.

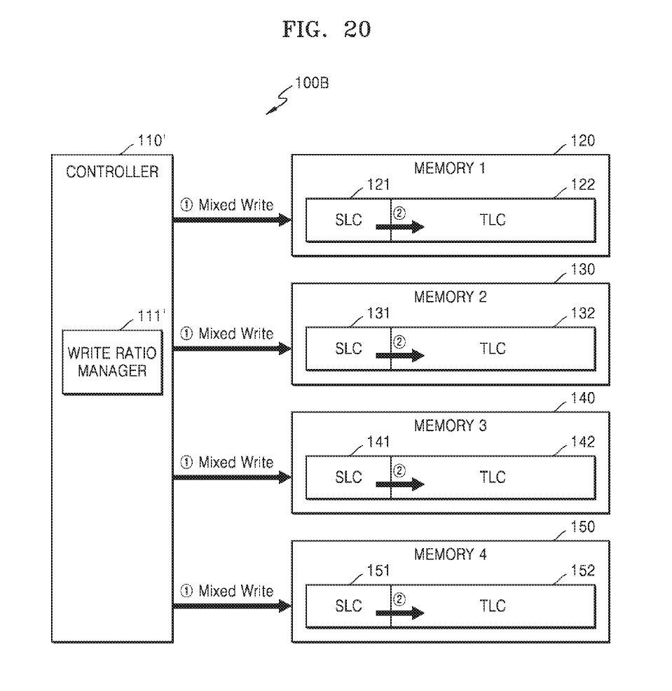

FIG. 20 illustrates the mixed write operations of FIG. 19, according to an exemplary embodiment of the inventive concept.

Referring to FIG. 20, in the case of the first to third mixed write operations 191 to 193 of FIG. 19, the write data may be mixedly written to the SLC regions 121, 131, 141, and 151 and the TLC regions 122, 132, 142, and 152. Specifically, the write data may be divided into a plurality of pieces of partial data, and the plurality of pieces of partial data may be sequentially output to the controller 110′ and then alternately stored in the SLC regions 121, 131, 141, and 151 and the TLC regions 122, 132, 142, and 152. Then, the data stored in the SLC regions 121, 131, 141, and 151 may be respectively migrated to the TLC regions 122, 132, 142, and 152.

According to the present embodiment, since pieces of the write data are mixedly written to the SLC regions 121, 131, 141, and 151 and the TLC regions 122, 132, 142, and 152, the amount of data written to the SLC regions 121, 131, 141, and 151 may be reduced as compared to the SLC write operation. Thus, a consuming speed of the SLC regions 121, 131, 141, and 151 may decrease as compared to the SLC write operation. Therefore, a migration execution time point may be delayed as compared to the SLC write operation. Thus, the WAF and power consumption may be reduced, and the update of the program/erase cycle count for the SLC regions 121, 131, 141, and 151 may be performed at a slower speed.

Therefore, when the mixed write operation is performed, the write performance of the storage device 100B may be maintained to be high, as compared to the TLC write operation, due to a mixture of a relatively fast write speed of the SLC regions 121, 131, 141, and 151 and a relatively slow write speed of the TLC regions 122, 132, 142, and 152. Also, the section where the storage device 100B can maintain the constant performance is long, as compared to the SLC write operation, and the buffer size that can provide the constant performance is large, as compared to the SLC write operation. Furthermore, since the update of the program/erase cycle count for the SLC regions 121, 131, 141, and 151 is performed at a slower speed, the lifetime of the SLC regions 121, 131, 141, and 151 may increase, resulting in an increase in the lifetime of the storage device 100B.

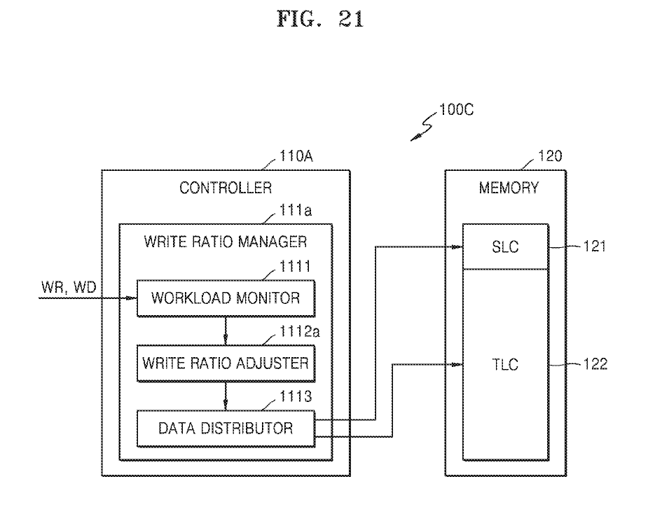

FIG. 21 is a block diagram illustrating another example 100C of the storage device 100 of FIG. 1, according to an exemplary embodiment of the inventive concept.

Referring to FIG. 21, the storage device 100C includes a controller 110A (e.g., a control circuit) and a memory 120. The memory 120 may be a single memory chip, or may include a plurality of memory chips. The controller 110A includes a write ratio manager 111a, and the write ratio manager 111a includes a workload monitor 1111, a write ratio adjuster 1112a, and a data distributor 1113.

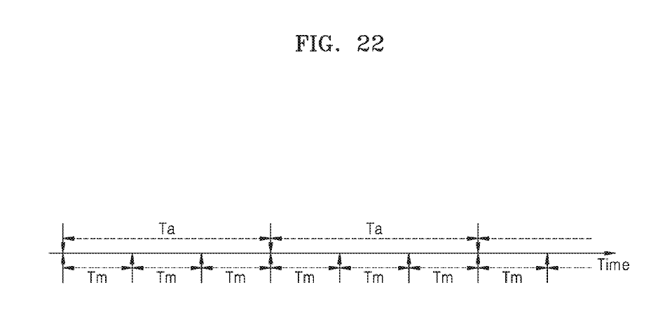

The workload monitor 1111 may receive a write request WR and write data WD from the host 200 and monitor a workload of the storage device 100C based on a frequency of the received write request WR and a size of the received write data WD. The write ratio adjuster 1112a receives a result of the monitoring from the workload monitor 1111 and dynamically adjusts the write ratio based on the received result of the monitoring. The data distributor 1113 distributes the write data WD according to the adjusted write ratio and provides the distributed write data WD to the SLC region 121 and the TLC region 122. The operation of the workload monitor 1111 will be described in detail with reference to FIG. 22.

FIG. 22 is a graph showing first and second periods Ta and Tm during which the workload monitor 1111 of FIG. 21 operates.

Referring to FIGS. 1, 21, and 22, the workload monitor 1111 accumulates the write request WR and the write data WD received from the host 200 during the first period Ta and monitors performance required by the host 200 every first period Ta. The first period Ta may also be referred to as a workload determination period, a performance determination period, or a write ratio determination period. The workload monitor 1111 provides the monitored performance to the write ratio adjuster 1112a, and the write ratio adjuster 1112a may adjust the write ratio in real time according to the monitored performance.

For example, when the performance monitored during the first period Ta is 1,400 MB/s, the performance required by the host 200 may be determined as being relatively high. In this case, the write ratio adjuster 1112a may adjust the write ratio so that the amount of data written to the SLC region 121 among all the write data is increased. Since the write speed of the SLC region 121 is fast, all the write data may be written at a fast speed. Therefore, the storage device 100C may provide write performance adaptive to the monitored performance.

On the other hand, for example, when the performance monitored during the first period Ta is 300 MB/s, the performance required by the host 200 may be determined as being relatively low. In this case, the write ratio adjuster 1112a may adjust the write ratio so that the amount of data written to the SLC region 121 among all the write data is reduced. Due to the reduction in the amount of data written to the SLC region 121, a consuming speed of the SLC region 121 may decrease and a migration time point may be delayed. Therefore, the storage device 100C may provide an improved buffer size and lifetime.

Also, the workload monitor 1111 may detect a heavy workload by accumulating the write request WR and the write data WD received from the host 200 during the second period Tm and monitoring performance required by the host 200 every second period Tm. The second period Tm may also be referred to as a heavy workload detection period. The second period Tm may be shorter than the first period Ta, or may be equal to the first period Ta.

In an embodiment, the workload monitor 1111 compares a workload with a threshold value based on the write request WR and the write data WD received from the host 200 during the second period Tm. For example, the threshold value may correspond to a maximum performance expected when a write operation is performed at a current set write ratio. In an embodiment, when the workload is greater than or equal to the threshold value, the write ratio adjuster 1112a adjusts the write ratio so that the write data is written to only the SLC region 121.

As such, when the performance monitored during the second period Tm reaches the maximum performance expected when the write operation is performed at the current set write ratio, the workload monitor 1111 may determine the monitored performance as a heavy workload. When the heavy workload is detected, the write ratio adjuster 1112a may adjust the write ratio to be 1:0 and switch the write mode to the SLC write mode of performing the write operation on only the S LC region 121.

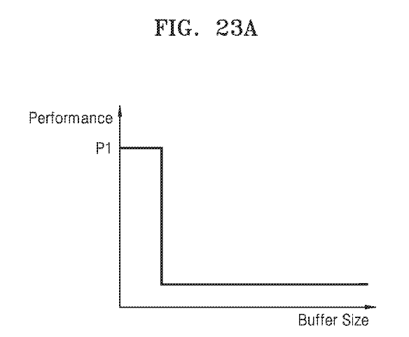

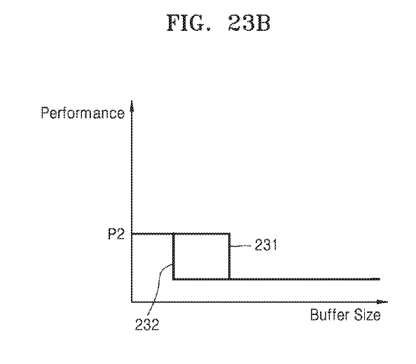

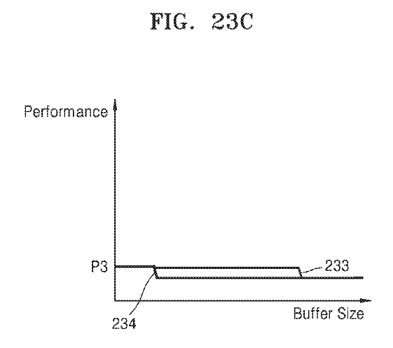

FIGS. 23A to 23C are graphs showing the operation of the storage device according to the workload, according to an embodiment of the inventive concept. Hereinafter, the operation of the storage device according to the workload will be described with reference to FIGS. 21 and 23A to 23C. In FIGS. 23A to 23C, the horizontal axis represents buffer size and the vertical axis represents performance.

Referring to FIG. 23A, when the performance monitored by the workload monitor 1111 is P1, the write ratio adjuster 1112a may determine that P1 is a heavy workload, and adjust the write ratio to be 1:0. The data distributor 1113 may provide the write data to only the SLC region 121 according to the write ratio, and the write data may be stored in only the SLC region 121. Therefore, the storage device 100C may provide the maximum performance adaptive to the monitored performance.

Referring to FIG. 23B, when the performance monitored by the workload monitor 1111 is P2, the write ratio adjuster 1112a may determine that P2 is a normal workload, and adjust the write ratio to be X:1 (X>0). The data distributor 1113 may provide the write data to the SLC region 121 and the TLC region 122 that are mixed at the ratio of X:1, and the write data may be stored in the SLC region 121 and the TLC region 122. As compared to an SLC write operation 232, a mixed write operation 231 according to the adjustment of the write ratio may allow the storage device 100C to provide the performance P2 adaptive to the monitored performance for a longer time. In other words, the storage device 100C may increase the buffer size that provides the constant performance P2 due to the dynamic adjustment of the write ratio.

Referring to FIG. 23C, when the performance monitored by the workload monitor 1111 is P3, the write ratio adjuster 1112a may determine that P3 is a light workload, and adjust the write ratio to be Y:1 (0<Y<X). The data distributor 1113 may provide the write data to the SLC region 121 and the TLC region 122 that are mixed at the ratio of Y:1, and the write data may be stored in the SLC region 121 and the TLC region 122. In an embodiment, the data distributor 1113 is implemented by one or more multiplexers or demultiplexers. As compared to an SLC write operation 234, a mixed write operation 233 according to the adjustment of the write ratio may allow the storage device 100C to provide the performance P3 adaptive to the monitored performance for a longer time. In other words, the storage device 100C may increase the buffer size that provides the constant performance P3 due to the dynamic adjustment of the write ratio.

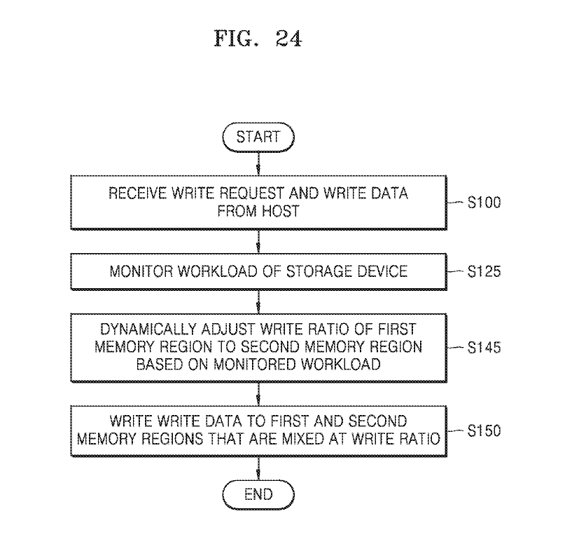

FIG. 24 is a flowchart of a method of operating a storage device, according to an exemplary embodiment of the inventive concept.

Referring to FIG. 24, the method of operating a storage device, according to the present embodiment, may be an operation of writing data to the storage device and may include, for example, operations performed in time series by the storage device 100C of FIG. 21. The descriptions provided with reference to FIGS. 21 to 23C may be applied to the present embodiment, and therefore redundant descriptions will be omitted.

In operation S100, a write request and write data are received from the host. In operation S125, a workload of the storage device 100C is monitored. Specifically, the workload monitor 1111 may receive a write request WR and write data WD from the host and monitor a workload of the storage device 100C based on a frequency of the received write request WR and a size of the received write data WD. For example, that workload monitor 1111 could determine that workload is high when the frequency and/or the size is higher than a threshold.

In operation S145, a write ratio of a first memory region to a second memory region is dynamically adjusted based on the monitored workload. Specifically the write ratio adjuster 1112a may receive the result of the monitoring from the workload monitor 1111 and dynamically adjust the write ratio based on the received result of the monitoring. In operation S150, the write data is written to the first and second memory regions that are mixed at the adjusted write ratio.

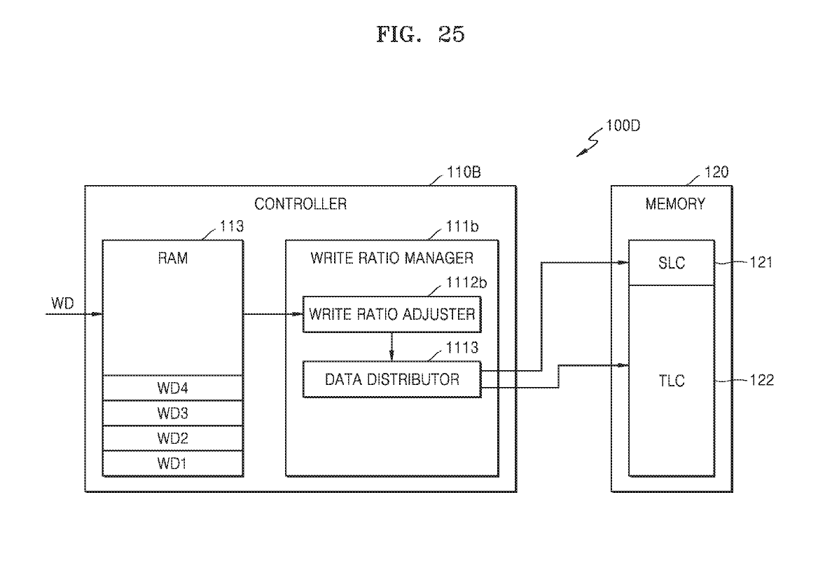

FIG. 25 is a block diagram illustrating another example 100D of the storage device 100 of FIG. 1, according to an exemplary embodiment of the inventive concept.

Referring to FIG. 25, the storage device 100D includes a controller 110B and a memory 120. The memory 120 may be a single memory chip, or may include a plurality of memory chips. The controller 110B includes a write ratio manager 111b and RAM 113, and the write ratio manager 111b includes a write ratio adjuster 1112b and a data distributor 1113.

Write data WD received from the host may be buffered in the RAM 113. In this case, the RAM 113 may be used as a buffer. The write ratio adjuster 1112b may dynamically adjust the write ratio based on the amount of write data WD1 to WD4 buffered in the RAM 113. Specifically, when a large amount of write data is buffered in the RAM 113, the write ratio adjuster 1112b may determine that the performance required by the host is relatively high, and may increase the write ratio with respect to the SLC region 121 among all the write data so as to improve the write speed. On the other hand, when a small amount of write data is buffered in the RAM 113, the write ratio adjuster 1112b may determine that the performance required by the host is relatively low, and may reduce the write ratio with respect to the SLC region 121 among all the write data. For example, when the amount of write data buffered in the RAM 113 is less than or equal to a threshold, the write ratio adjuster 1112b may determine that the performance required by the host is low, and when the amount exceeds the threshold, the write ratio adjuster 1112b may determine that the performance required by the host is high.

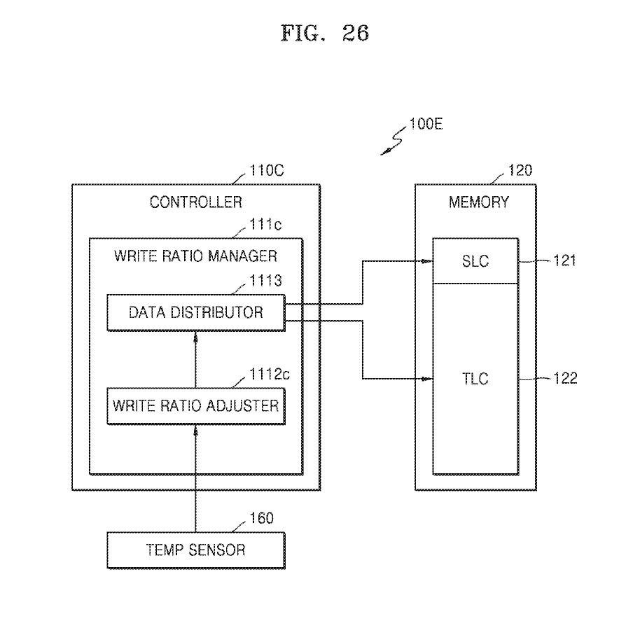

FIG. 26 is a block diagram illustrating another example 100E of the storage device 100 of FIG. 1, according to an exemplary embodiment of the inventive concept.

Referring to FIG. 26, the storage device 100E includes a controller 110C, a memory 120, and a temperature sensor 160 (e.g., a temperature sensing circuit). The memory 120 may be a single memory chip, or may include a plurality of memory chips. The controller 110C includes a write ratio manager 111c, and the write ratio manager 111b includes a write ratio adjuster 1112b and a data distributor 1113. The temperature sensor 160 senses a temperature of the storage device 100E and provides sensed temperature information to the write ratio adjuster 1112c. The write ratio adjuster 1112c may dynamically adjust the write ratio based on the temperature information.

In an exemplary embodiment, when the sensed temperature is higher than a reference temperature, the write ratio adjuster 1112c increases the amount of data written to the SLC region 121 among all the write data. Since the write speed of the SLC region 121 is faster than the write speed of the TLC region 122, the entire write speed may be increased and a completion time point of a write operation may be quickened. Thus, an idle time of the storage device 100E may be increased and the temperature of the storage device 100E may decrease. Also, when the sensed temperature is higher than the reference temperature, the stability of the TLC region 122 is weaker than the stability of the SLC region 121. Thus, the stability of the write operation may be secured by increasing the write ratio with respect to the SLC region 121. In an exemplary embodiment, when the sensed temperature is lower than the reference temperature, the write ratio adjuster 1112c reduces the amount of data written to the SLC region 121 among all the write data. Since the write speed of the TLC region 122 is slower than the write speed of the SLC region 121, the entire write speed may be reduced and a completion time point of a write operation may be delayed. Thus, an idle time of the storage device 100E may be reduced and the temperature of the storage device 100E may increase.

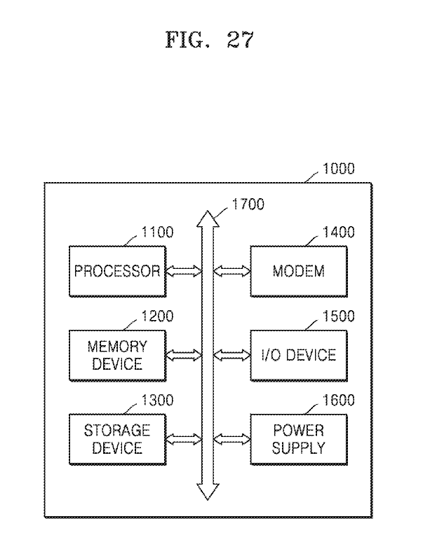

FIG. 27 is a block diagram of an electronic apparatus 1000 according to an exemplary embodiment of the inventive concept.

Referring to FIG. 27, the electronic apparatus 1000 includes a processor 1100, a memory device 1200, a storage device 1300, a modem 1400, an input/output (I/O) device 1500, and a power supply 1600. In the present embodiment, the memory device 1200 and/or the storage device 1300 may include first and second memory regions having different performances and may dynamically adjust a write ratio of the first memory region to the second memory region and write the write data to the first and second memory regions that are mixed at the adjusted write ratio. The descriptions provided with reference to FIGS. 1 to 26 may be applied to the memory device 1200 and/or the storage device 1300.

While the inventive concept has been particularly shown and described with reference to embodiments thereof, it will be understood that various changes in form and details may be made therein without departing from the spirit and scope of the inventive concept.

1. A method of operating a storage device including first and second memory regions, the method comprising:
adjusting, by a controller of the storage device, a write ratio of the first memory region to the second memory region for write data received from a host in response to a write request from the host; and
writing, by the controller, the write data to the first and second memory regions at the adjusted write ratio,
wherein the first memory region includes memory cells having a first write speed, and
wherein the second memory region includes memory cells having a second write speed that is different from the first write speed.

2. The method of claim 1, wherein the first memory region is a single level cell (SLC) region, and the second memory region is a multi level cell (MLC) region or a triple level cell (TLC) region.

3. The method of claim 1, wherein the write ratio corresponds to a ratio of a number of blocks selected from the first memory region to a number of blocks selected from the second memory region, a ratio of a number of pages selected from the first memory region to a number of pages selected from the second memory region, or a ratio of a number of word lines selected from the first memory region to a number of word lines selected from the second memory region,

4. The method of claim 1, wherein the writing comprises:
dividing the write data into a plurality of pieces of partial data; and
alternately writing the plurality of pieces of partial data to the first and second memory regions.

5. The method of claim 1, wherein the writing comprises alternately and repetitively performing a first write operation on the first memory region and a second write operation on the second memory region, and
switching between performing the first write operation and the second write operation in word line units.

6. The method of claim 1, wherein the adjusting comprises dynamically adjusting the write ratio according to a requirement of the host,

7. The method of claim 1, wherein the adjusting comprises dynamically adjusting the write ratio based on a write mode received from the host, the write mode indicating the write ratio.

8. The method of claim 7, further comprising: the controller providing the host with information about at least one of performance, buffer size, and lifetime of the storage device according to the write ratio before receiving the write mode.

9. The method of claim 1, wherein the adjusting comprises dynamically adjusting the write ratio based on at least one of a size of the received write data and a frequency of the received write request.

10. The method of claim 1, wherein the adjusting comprises dynamically adjusting the write ratio based on state information of the first and second memory regions, and
the state information comprises at least one of program/erase cycle information of the first and second memory regions, a number of free blocks in the first and second memory regions, and data retention time information of the first and second memory regions.

11. The method of claim 1, wherein the first memory region is a volatile memory and the second memory region is a non-volatile memory.

12. The method of claim 1, wherein the first and second memory regions are volatile-memories.

13. The method of claim 1, wherein the first and second memory regions are non-volatile memories.

14. A method of operating a storage device including first and second memory regions, the method comprising:
monitoring, by a controller of the storage device, a workload of the storage device based on a write request and write data received from a host during a first period;
adjusting, by the controller, a write ratio of the first memory region to the second memory region for the received write data based on the monitored workload; and
writing, by the controller, the write data to the first and second memory regions at the adjusted write ratio,
wherein the first memory region includes memory cells having a first write speed, and
wherein the second memory region includes memory cells having a second write speed that is different from the first write speed.

15. The method of claim 14, wherein the first memory region is a single level cell (SLC) region, and the second memory region is a multi level cell (MLC) region or a triple level cell (TLC) region.

16. The method of claim 15, wherein the adjusting comprises:
comparing the workload with a threshold value based on the write request and the write data received from the host during a second period that is shorter than the first period; and
changing the write ratio so that the write data is written to only the SLC region when the workload is greater than or equal to the threshold value.

17. The method of claim 1.4, wherein the adjusting comprises dynamically adjusting the write ratio based on an amount of data buffered in random access memory (RAM) of the storage device or a temperature of the storage device.

18. The method of claim 14, wherein the write ratio corresponds to a ratio of a number of blocks selected from the first memory region to a number of blocks selected from the second memory region, a ratio of a number of pages selected from the first memory region to a number of pages selected from the second memory region, or a ratio of a number of word lines selected from the first memory region to a number of word lines selected from the second memory region.

19. A storage device comprising:
a memory comprising a first memory region including memory cells having a first write speed and a second memory region including memory cells having a second write speed that is different from the first write speed; and
a controller configured to receive a write request and write data from a host, to dynamically adjust a write ratio of the first memory region to the second memory region for the received write data, and to control the memory to write the write data to the first and second memory regions at the adjusted write ratio.

20. The storage device of claim 19, wherein the first memory region is a single level cell (SLC) region, and the second memory region is a multi level cell (MLC) region or a triple level cell (TLC) region.

21-23. (canceled)
